(19) United States
(12) Patent Application Publication
(10) Pub. No.: US 2021/0179356 A1
(43) Pub. Date: Jun. 17, 2021

(54) METHOD OF AUTOMATED ORDER PICKING, AND SYSTEM IMPLEMENTING THE SAME

(71) Applicant: SOLOMON TECHNOLOGY CORPORATION, Taipei City (TW)

(72) Inventors: Cheng-Lung CHEN, Taipei City (TW); Yu-Yen LIU, Taipei City (TW); Xuan Loc NGUYEN, Taipei City (TW); Tsung-Cheng LAI, Taipei City (TW)

(21) Appl. No.: 17/118,057

(22) Filed: Dec. 10, 2020

(30) Foreign Application Priority Data
Dec. 11, 2019 (TW) 108145309
Jul. 22, 2020 (TW) 109124842

(51) Int. Cl. B65G 1/137; G06T 7/62; G06K 9/00; B25J 9/16

(52) U.S. Cl. CPC B65G 1/1375; G06T 7/62; H04N 13/243; B25J 9/1697; G06T 2207/10012; G06K 9/00624

(57) ABSTRACT

A method of automated order picking is provided. A control device uses camera devices and a code reader unit to acquire identification codes and volumes of multiple objects when controlling a robotic arm to bring the objects from a first platform to a second platform one by one. Upon determining that the objects on the second platform include all order items of an order based on the identification codes, the control devices selects a packing box that fits the order items in volume, and controls another robotic arm to take the order items from the second platform to the packing box.

### CROSS-REFERENCE TO RELATED APPLICATION

This application claims priority of Taiwanese Invention Patent Application Nos. 108145309 and 109124842, respectively filed on Dec. 11, 2019 and Jul. 22, 2020.

### FIELD

The disclosure relates to an order picking method that is adapted for warehouse logistics, and more particularly to a method of automated order picking.

### BACKGROUND

Nowadays, in warehouses for e-commerce businesses, distribution logistics or factories, automated picking systems have been gradually introduced to assist and guide pickers to perform picking correctly, rapidly and easily. After the picking process is completed, the picking baskets are transported to a packing station via conveyor belts, and then a packer proceeds with quality assurance, sealing and labeling. However, once the picking basket arrives at the packing station, the packer must decide which size of box should be used for packing. Incorrect decision may result in waste of resource and time. If the packer decides to use an oversized box for packing, it would be a waste of packaging material.

If the packer decides to use an undersized box for packing, repacking may be required because of insufficient inner space of the box, resulting in a waste of time. Manual packing is therefore a hindrance to improving packing and shipping efficiency of products.

### SUMMARY

Therefore, an object of the disclosure is to provide a method of automated order picking, and a system that implements the method. The method can alleviate at least one of the drawbacks of the prior art.

According to one embodiment of the disclosure, the system includes a control device, a first three-dimensional (3D) camera device, a first robotic arm, a code reader unit, a second 3D camera device and a second robotic arm. Each of the first 3D camera device, the first robotic arm, the code reader unit, the second 3D camera device and the second robotic arm is electrically connected to and controlled by the control device. The method includes: A) by the first 3D camera device, capturing a first 3D image of first-platform objects that are placed on a first platform, and transmitting the first 3D image to the control device; B) by the control device, controlling a first robotic arm to pick up one of the first-platform objects that is placed on the first platform based on the first 3D image; C) by the code reader unit, acquiring an identification code of the picked one of the first-platform objects, and transmitting the identification code to the control device; D) by the second 3D camera device, capturing a second 3D image of the picked one of the first-platform objects, and transmitting the second 3D image to the control device; E) by the control device, calculating a volume of the picked one of the first-platform objects based on the second 3D image; F) by the control device, controlling the first robotic arm to place the picked one of the first-platform objects on an area of a second platform that is currently empty, the picked one of the first-platform objects that has been put on the second platform serving as a second-platform object; G) repeating steps A)to F) to make the second platform have a plurality of the second-platform objects thereon; H) by the control device, upon determining that the second-platform objects include all order items of an order based on the identification codes that correspond to the second-platform objects, selecting a packing box of which a size fits the volumes of the order items, and controlling the second robotic arm to pick up the order items from the second platform and to place the order items into the packing box.

According to another embodiment of the disclosure, the system includes a control device, a 3D camera device and a robotic arm. Each of the 3D camera device and the robotic arm is electrically connected to and controlled by the control device. The method includes: A) by the 3D camera device, capturing a 3D image of at least one object that is included in an order and that is placed on a platform, and transmitting the 3D image to the control device; B) by the control device, calculating a volume of the at least one object based on the 3D image; and by the control device, selecting a packing box of which a size fits the volume of the at least one object, and controlling the robotic arm to pick up the at least one object from the platform and to place the at least one object into the packing box.

### BRIEF DESCRIPTION OF THE DRAWINGS

Other features and advantages of the disclosure will become apparent in the following detailed description of the embodiment(s) with reference to the accompanying drawings, of which:

FIG. 1 is a flow chart illustrating steps of a first embodiment of a method of automated order picking according to the disclosure;

FIG. 2 is a schematic diagram illustrating a first exemplary system that implements the first embodiment;

FIG. 3 is a schematic diagram illustrating a variation of the first exemplary system;

FIG. 4 is a schematic diagram illustrating a second exemplary system that implements the first embodiment; and

FIG. 5 is a schematic diagram illustrating a third exemplary system that implements a second embodiment of a method of automated order picking according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

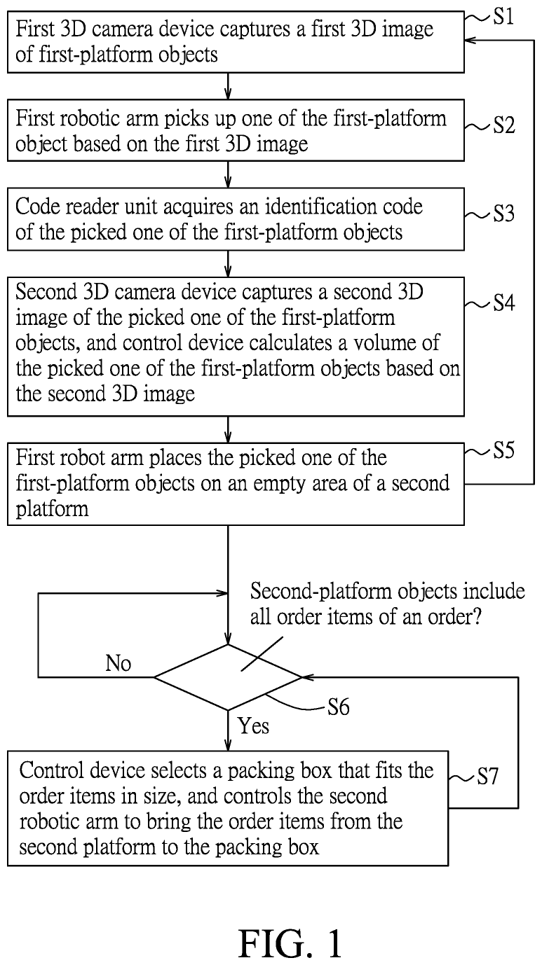

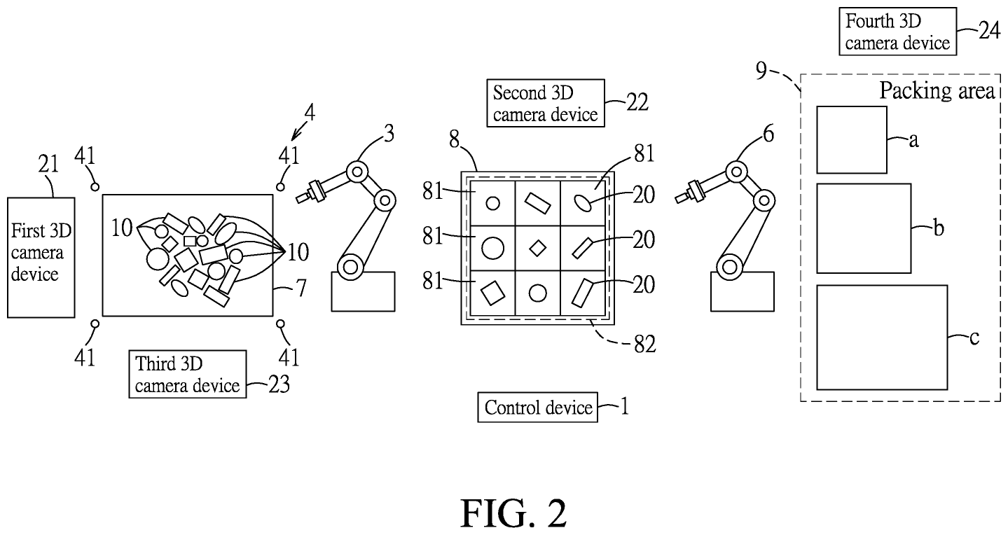

FIG. 1 is a flow chart illustrating steps of a first embodiment of a method of automated order picking according to this disclosure. FIG. 2 shows a first exemplary system that implements the first embodiment. The first exemplary system includes a control device 1, a first three-dimensional (3D) camera device 21, a first robotic arm 3, a code reader unit 4, a second 3D camera device 22, and a second robotic arm 6. Each of the first 3D camera device 21, the first robotic arm 3, the code reader unit 4, the second 3D camera device 22, and the second robotic arm 6 is electrically connected to (or in communication with) and controlled by the control device 1 (the figure does not depict such electrical connections). In this embodiment, the control device 1 may be realized as an industrial computer, but this disclosure is not limited thereto. The first 3D camera 21 is used to capture a 3D image (referred to as first 3D image hereinafter) of a plurality of objects (referred to as first-platform objects 10) that are placed on a first platform 7 that is located in a first platform area, and transmits the first 3D image to the control device 1. The first-platform objects 10 are randomly placed or stacked on the first platform 7. The first robotic arm 3 is disposed next to the first platform 7 in the first platform area, and is controlled by the control device 1 to pick up (e.g., using a sucking disc or a suction nozzle thereof) one of the first-platform objects 10 and place the picked one of the first-platform objects 10 on a second platform 8 that is located in a second platform area.

In this embodiment, the code reader unit 4 includes a plurality of barcode scanners 41 that are disposed next to the first platform 7 in the first platform area. In this embodiment, the code reader unit 4 is exemplified to include four barcode scanners 41 that are respectively positioned next to four corners or four sides of the first platform 7 but this disclosure is not limited to such. In practice, a number of barcode scanners 41 included in the code reader unit 4 and locations of the barcode scanners 41 may be adjusted as required. In other embodiments, the code reader unit 4 may be a radio-frequency identification (RFID) tag reader. In other embodiments, the barcode scanners 41 may be disposed in the second platform area (e.g., next to the second platform 8). The second 3D camera device 22 is disposed next to the second platform 8, and is controlled by the control device 1 to capture a 3D image (referred to as second 3D image hereinafter) of the picked one of the first-platform objects 10, and to transmit the second 3D image to the control device 1. In other embodiments, the second 3D camera device 22 may be disposed in the first platform area (e.g., next to the first platform 7). The second robotic arm 6 is disposed next to the second platform 8, is proximate to a packing area 9, and is controlled by the control device 1 to pick up one of multiple objects (referred to as second-platform objects 20 hereinafter) that are disposed on the second platform 8, and to place the picked one of the second-platform objects 20 into a packing box that is placed in the packing area 9. The second-platform objects 20 may be those of the first-platform objects 10 that were picked up from the first platform 7 and placed on the second platform 8 by the first robotic arm 3.

In this embodiment, the packing area 9 may be provided with a plurality of boxes of different sizes in advance. As exemplarily shown in FIG. 2, three boxes (a, c) of different sizes are placed in order of size in the packing area 9 in advance, and the control device 1 may select one of the boxes (a, b, c) for placement of the picked one of the second-platform objects 20 therein. In other embodiments, the packing area 9 may be provided with only one box of which a size is determined by the control device for placement of the picked one of the second-platform objects 20 therein.

Upon receipt of one or more orders, the control device 1 may perform steps as shown in FIG. 1 for packing and shipping order items (i.e., objects that are included in the order(s)) according to the order(s).

In step S1, the control device 1 controls the first 3D camera device 21 to capture the first 3D image of the first-platform objects 10 that are placed on the first platform 7, and to transmit the first 3D image to the control device 1.

In step S2, the control device 1 analyzes the first 3D image to select one of the first-platform objects 10 to pick up, and controls the first robotic arm 3 to pick up the selected one of the first-platform objects 10 from the first platform 7. In this embodiment, the selected one of the first-platform objects 10 is the one that is easiest to be picked up by the first robotic arm 3 (e.g., the nearest one and/or the highest one (at the most elevated position relative to the first platform 7)), but this disclosure is not limited in this respect.

In step S3, the control device 1 controls the code reader unit 4 to acquire an identification code of the picked one of the first-platform objects 10, and to transmit the identification code to the control device 1. In case that the code reader unit 4 includes multiple barcode scanners 41 that are next to the first platform 7 (or the second platform 8), when the first robotic arm 3 brings and moves the picked one of the first-platform objects 10 to be above the first platform 7 (or the second platform 8), the barcode scanners 41 will scan a barcode disposed on the picked one of the first-platform objects 10 that is currently held by the first robotic arm 3 to acquire the identification code. In case that the code reader unit 4 is an RFID tag reader that is next to the first platform 7 (or the second platform 8), when the first robotic arm 3 brings and moves the picked one of the first-platform objects 10 to be above the first platform 7 (or the second platform 8), the RFID tag reader will read an RFID tag disposed on the picked one of the first-platform objects 10 that is currently held by the first robotic arm 3 to acquire the identification code.

In step S4, when the picked one of the first-platform objects 10 is taken and moved by the first robotic arm 3 to be above the second platform 8 (or the first platform 7), the control device 1 controls the second 3D camera device 22 that is disposed next to the second platform 8 (or the first platform 7) to capture the second 3D image of the picked one of the first-platform objects 10, and to transmit the second 3D image to the control device 1. The control device 1 calculates a volume of the picked one of the first-platform objects 10 based on the second 3D image, and records a correspondence between the volume thus calculated and the identification code that corresponds to the picked one of the first-platform objects 10. It is noted that the term “volume” herein is not merely limited to referring to amount of space occupied by an object, but may also refer to measures of multiple dimensions of the object. Since calculation of the volume/dimensions of the picked one of the first-platform objects 10 is well known in the art, details thereof are omitted herein for the sake of brevity. For example, a plane where a flange face of the first robotic arm 3 is located may serve as a reference plane for defining z=0, which can be used to calculate a minimum cube that encloses the point cloud of the picked one of the first-platform objects 10, and the volume/dimensions of the minimum cube can serve as the volume/dimensions of the picked one of the first-platform objects 10.

In step S5, the control device 1 controls the first robotic arm 3 to place the picked one of the first-platform objects 10 on an empty area of the second platform 8 (i.e., an area of the second platform 8 that is currently not occupied by any object). As a result, the picked one of the first-platform objects 10 that has been put on the second platform 8 serves as a second-platform object 20. In this embodiment, the second platform 8 is configured to have a plurality of placement areas 81 that are arranged in an array. As exemplified in FIG. 2, the second platform 8 has nine placement areas 81 (only four of which are labeled) that are arranged in a 3×3 array. In other embodiments, the second platform may be configured to have different number of placement areas 81, which may be arranged in, for example, a 2×3 array, a 2×5 array, a 3×5 array, a single row, a single column, etc., and this disclosure is not limited in this respect. Specifically in this embodiment, the control device controls the first robotic arm 3 to place the picked one of the first-platform objects 10 on an empty one of the placement areas 81 where no object is placed thereon (i.e., the empty area). Since the placement areas 81 are configured in advance, the control device 1 pre-stores coordinates of each of the placement areas 81. When the picked one of the first-platform objects 10 is placed on the empty area, the control device 1 records correspondence among the coordinates of the area that has been occupied by the picked one of the first-platform objects 10, the volume of the picked one of the first-platform objects 10 and the identification code that corresponds to the picked one of the first-platform objects 10, and updates information that indicates a usage status (e.g., empty or occupied) of each of the placement areas 81. In some cases that a distance between the first platform 7 and the second platform is so long that the first robotic arm 3 cannot bring an object from one to the other, a track (not shown) that extends from the first platform area to the second platform area may be provided, so that the first robotic arm 3 can be placed on the track and be movable between the first platform area and the second platform area.

After step S5, the control device 1 controls the first 3D camera device 21, the first robotic arm 3, the code reader unit 4 and the second 3D camera device 22 to repeat steps S1 to S5 for bringing another one of the first-platform objects 10 to the second platform 8, so as to make the second platform 8 have a plurality of the second-platform objects 20 thereon.

Meanwhile, in step S6, the control device 1 continuously determines, based on the identification codes that correspond to the second-platform objects (i.e., the objects that are currently placed on the second platform 8), whether the second-platform objects 20 include all order items of a single order. It is noted that each of the order items has an identification code, and the control device compares the identification codes of the second-platform objects 20 with the identification codes of the order items to make the determination. The flow goes to step Si when the determination is affirmative, and repeats step S6 when otherwise.

In step S7, the control device 1 selects a packing box of which a size fits the volumes of the order items combined (i.e., a combined volume of the order items), and controls the second robotic arm 6 to pick up the order items from the second platform 8 and to place the order items into the packing box. As an example, if an order includes a single order item or multiple order items (the plural form is used hereinafter for the sake of clarity, but this disclosure is not limited to such), and all of the order items have already been placed on the second platform 8 (i.e., the order items are part of the second-platform objects 20), the control device 1 selects, based on the volumes of the order items that were acquired in step S4 when the order items were taken from the first platform 7 to the second platform 8 (the order items were part of the first-platform objects 10 before being taken to the second platform 8), a packing box of which a size fits the combined volume of the order items the best. The control device 1 may adopt a conventional algorithm, such as random-order bin packing, best-fit bin-packing with random order, etc., to calculate an optimal packing arrangement (including planar arrangement and/or stacking of the order items) based on the volumes of the order items, and select the packing box based on the optimal packing arrangement thus calculated. In this embodiment, as exemplified in FIG. 2, the control device 1 selects the packing box from among the boxes (a, b, c) that are placed in the packing area 9. After the control device 1 controls the second robotic arm 6 to pick up the order items from the second platform 8 and to put the order items into the selected packing box one by one according to the optimal packing arrangement, the packing box will be sent to a shipment station (not shown) for sealing and shipping operations. Meanwhile, another empty box that has the same size as the selected packing box is placed onto the area where the selected packing box was located.

In other embodiments where no boxes are placed in the packing area 9 in advance, the control device 1 selects a box size for packing the order items from among a plurality of predetermined box sizes based on the volumes of the order items, and then the packing box of the selected box size is sent to the packing area 9 using a conveyor mechanism (not shown). In some cases that a distance between the second platform 8 and the packing area 9 is so long that the second robotic arm 6 cannot bring an object from one to the other, a track (not shown) that extends from the second platform area to the packing area 9 may be provided, so that the second robotic arm 6 can be placed on the track and be movable between the second platform area and the packing area 9.

As an example, when an order has three order items, only two of which are placed on the second platform 8, the control device 1 will not perform step S7 for this order. Only after the remaining one of the order items is placed on the second platform S will the control device 1 perform step S7 for this order, where the control device 1 calculates an optimal packing arrangement for the three order items based on the volumes of the three order items, selects/determines a packing box that fits the volumes of the three order items based on the optimal packing arrangement, and controls the second robotic arm 6 to pick up the three order items from the second platform 8 and to put the three order items into the selected packing box one by one according to the optimal packing arrangement. Before the remaining one of the order items is placed on the second platform 8, if there is another order of which the order items are all placed on the second platform 8, the control device 1 will perform step S7 for said another order first.

In one implementation, the control device 1 may determine an optimal packing order for the order items based on the volumes of the order items in step S7, and then control the second robotic arm 6 to put the order items into the packing box according to the optimal packing order. For example, an order item that has a greater volume may be put into the packing box before an order item that has a smaller volume. If an order has a first order item, a second order item and a third order item where the three order items from greatest to smallest in terms of volume are the second order item, the first order item, and the third order item, then the second, first and third order items will be put into the packing box in the given order.

In another implementation, the second platform 8 includes a weighing scale 82 that is used to measure a weight of the second-platform objects 20 placed on the second platform 8. The control device 1 acquires a weight of each of the second-platform objects 20 based on the weight measured by the weighing scale 82 after the picked one of the first-platform objects (i.e., new second-platform object 20) is placed on the second platform 8 in step S5. The weighing scale 82 is reset when the placement areas 81 of the second platform 8 are all empty, so when an object is placed on the second platform 8 (i.e., the first second-platform object 20 that is put on the second platform 8), the weighing scale 82 directly measures and transmits the weight of the object (referred to as first weight hereinafter) to the control device 1. When another object is subsequently placed on the second platform 8 (i.e., becoming a second-platform object 20 that is put on the second platform 8), the weighing scale 82 transmits a total weight measured thereby (referred to as second weight hereinafter) to the control device 1, and the control device 1 subtracts the first weight from the second weight to obtain a weight of the another object. Accordingly, the weight of each of the second-platform objects 20 can be acquired in such a manner. In addition, when one of the second-platform objects 20 is taken away from the second platform 8, the weighing scale 82 will transmit a newly measured weight to the control device 1, so the control device 1 can keep the overall weight of the remaining second-platform objects 20 up to date in order to properly calculate the weight of a newly arrived second-platform object 20. Furthermore, the control device 1 records and stores, for each of the second-platform objects 20, correspondence among the identification code, the volume, the coordinates of the placement area 81 and the weight that correspond to the second-platform object 20 in a database (not shown). Then, the control device 1 controls in step S7, based on the weights of the second-platform objects 20, the second robotic arm 6 to put the order items into the packing box in an order (optimal packing order) from heaviest to lightest. In such a scenario, if an order has a first order item, a second order item and a third order item where the three order items from greatest to smallest in terms of weight are the first order item, the second order item, and the third order item, the first, second and third order items will be put into the packing box in the given order.

In yet another implementation, the control device 1 may take both the volume and the weight of each of the second-platform objects 20 and the optimal packing arrangement into consideration in determining the optimal packing order.

Referring back to FIG. 1, after step S7, the flow goes back to step S6, and the control device continues to determine whether the second-platform objects 20 include all of order items of another order based on the identification codes that correspond to the second-platform objects 20.

In one example, the first platform 7 may be one of a plurality of drawers of a storage cabinet, and the first-platform objects 10 are prepared and placed in the drawer in advance according to an order (i.e., the first-platform objects 10 are the order items of the order). After the control device 1 or other control equipment controls the storage cabinet to open the drawer, the control device 1 can repeatedly perform steps S1 through S5 to control the first robotic arm 3 to bring the first-platform objects 10 to the second platform 8 (making the first-platform objects 10 become second-platform objects 20) one by one, acquire the identification codes, the volumes and the weights of the second-platform objects 20, determine that the second-platform objects 20 include all of the order items (i.e., all of the first-platform objects 10 that were placed in the drawer) of the order in step S6, and then control the second robotic arm 6 to put the order items that are placed on the second platform 8 into the packing box one by one in step S7. In some embodiments, the drawer may be provided with many different objects that are randomly arranged. In some embodiments, the drawer may be provided with many different objects that are arranged in order or placed in different spaces in the drawer that are separated by grids for the first robotic arm 3 to pick up one of the first-platform objects 10 that is specified by the control device 1.

It is noted that steps S6, S7 and the repetition of steps S1-S5 may be performed at the same time, so the first and second robotic arms 3, 6 may operate at the same time in order to promote work efficiency. When the first and second robotic arms 3, 6 simultaneously perform actions (i.e., placing an object and picking up an object) in relation to the second platform 8, the first and second robotic arms 3, 6 may collide with each other because their movement trajectories may overlap or cross each other. To avoid such condition, a collision avoidance mechanism may be applied to this embodiment. The collision avoidance mechanism is used by the control device 1 to calculate a first moving trajectory for the first robotic arm 3 and a second moving trajectory for the second robotic arm 6 in terms of time and path, so as to avoid collision between the first robotic arm 3 and the second robotic arm 6 when the first robotic arm 3 moves along the first moving trajectory and the second robotic arm 6 moves along the second moving trajectory. In one implementation of the collision avoidance mechanism, the control device 1 calculates the movement trajectories for the first and second robotic arms 3, 6 before the actions are performed, and compares the movement trajectories to predict whether the first and second robotic arms 3, 6 will collide with each other. If affirmative, the control device 1 may adjust a movement path or time of the action for one or both of the first and second robotic arms 3, 6, so as to avoid the collision. In another implementation of the collision avoidance mechanism, robotic arm controllers (not shown) that are respectively provided on the first and second robotic arms 3, 6 may transmit the movement trajectories of the corresponding first and second robotic arms 3, 6 to the control device 1 in real time, so the control device 1 can quickly determine whether the first and second robotic arms 3, 6 will collide with each other accordingly. If affirmative, the control device 1 may immediately adjust a movement path or time of the action for one or both of the first and second robotic arms 3, 6, so as to avoid the collision. In yet another implementation of the collision avoidance mechanism, an additional monitoring system (not shown) may be provided in the second platform area to monitor the movement trajectories for the first and second robotic arms 3, 6. The monitoring system transmits the monitored movement trajectories to the control device 1 in real time, so the control device 1 can quickly determine whether the first and second robotic arms 3, 6 will collide with each other accordingly. If affirmative, the control device 1 may immediately adjust a movement path or time of the action for one or both of the first and second robotic arms 3, 6, so as to avoid the collision.

In some embodiments, as exemplified in FIG. 2, the first exemplary system may further include a third 3D camera device 23 disposed in the first platform area. In such as case, when the first robotic arm 3 picks up one of the first-platform objects 10 that is selected by the control device 1 from the first platform 7 in step S3, the control device 1 controls the third 3D camera device 23 to capture a third 3D image of the first robotic arm 3 that is holding the picked one of the first-platform objects 10, and to transmit the third 3D image to the control device 1. The control device 1 analyzes the third 3D image to obtain a distance between a central point (e.g., a center of symmetry, a center of a figure, a centroid, etc., which can be defined as desired) of the picked one of the first-platform objects 10 and a contact point at which the first robotic arm 3 contacts the picked one of the first-platform objects 10. Then, in step S5, the control device 1 controls the first robotic arm 3 to place the picked one of the first-platform objects 10 on the selected area (an empty one of the placement areas 81) of the second platform 8 based on the distance between the contact point and the central point of the picked one of the first-platform objects 10, so that the picked one of the first-platform objects 10 is entirely disposed within the selected area.

In some embodiments, as exemplified in FIG. 2, the first exemplary system may further include a fourth 3D camera device 24 (packing-area 3D camera device) disposed in the packing area 9. In such a case, the control device 1 controls the fourth 3D camera device 24 to capture a fourth 3D image (3D box image) that shows an inner space of the packing box, and to transmit the fourth 3D image to the control device 1. The control device 1 analyzes the fourth 3D image to calculate a proper place in the packing box for each of the order items, so as to obtain the optimal packing arrangement for the order items with respect to the packing box based on the inner space of the packing box as shown in the fourth 3D image, and controls the second robotic arm 6 to place each of the order items into the respective proper place in the packing box based on the optimal packing arrangement thus obtained.

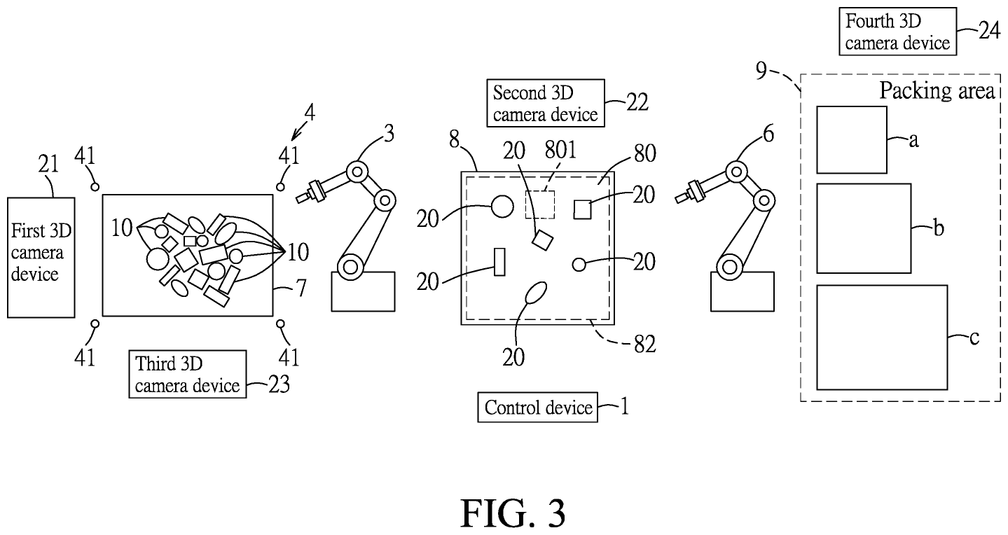

In some embodiment, as exemplified in FIG. 3, the second platform 8 may come without predetermined placement areas. In such a case, when the control device 1 controls the first robotic arm 3 to bring the picked one of the first-platform objects 10 to the second platform 8 in step S4, the second 3D image that is captured by the second 3D camera device 22 may contain a top surface of the second platform 8.

The control device 1 finds an empty area 801 of the second platform 8 for placement of the picked one of the first-platform objects 10 based on the volume of the picked one of the first-platform objects 10 and the top surface of the second platform 8 as shown in the second 3D image. Then, the control device 1 controls the first robotic arm 3 to place the picked one of the first-platform objects 10 on the area 801 of the second platform 8 thus determined in step S5, and records correspondence among coordinates of the area 801 that is now occupied by the picked one of the first-platform objects 10, the volume of the picked one of the first-platform objects 10 and the identification code that corresponds to the picked one of the first-platform objects 10. In step S7, the control device 1 controls the second robotic arm 6 to pick up each of the order items from the second platform 8 based on the coordinates that correspond to the identification code of the order item, and to put the order item into the packing box.

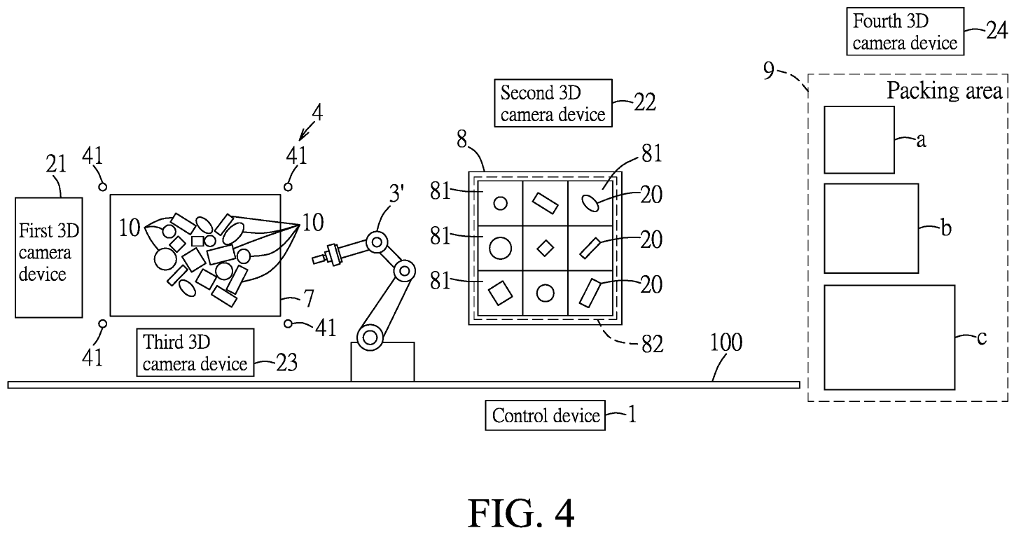

Referring to FIG. 4, a second exemplary system that implements the first embodiment is shown to differ from the first exemplary system in: (1) that only a single robotic arm 3′ is used in the second exemplary system instead of the first and second robotic arms 3 and 6 that are used in the first exemplary system; (2) that the second exemplary system includes a track 100 (also known as the seventh axis of a robotic arm) that extends from the first platform area to the packing area 9 through the second platform area, and the robotic arm 3′ is disposed on the track 100, thereby being movable between the first platform area and the second platform area, and between the second platform area and the packing area 9. In case that the first platform 7, the second platform 8 and the packing area 9 are close to each other so that the robotic arm 3′ can perform actions in relation to each of the first platform 7, the second platform 8 and the packing area 9 without movement of its base, the track 100 can be omitted.

When the first embodiment is performed using the second exemplary system, the first and second robotic arms 3, 6 mentioned in the previous description in relation to the first exemplary system (see FIGS. 2 and 3) are regarded as the same robotic arm (i.e., the robotic arm 3′). In other words, all the actions of the first embodiment that are performed by the first and second robotic arms 3, 6 of the first exemplary system are executed by the robotic arm 3′ when the first embodiment is performed using the second exemplary system. Therefore, details of using the second exemplary system to perform the first embodiment are not repeated herein for the sake of brevity.

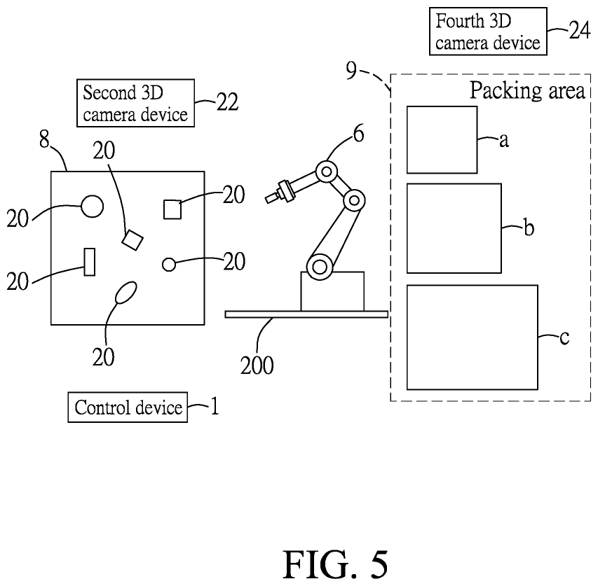

Referring to FIG. 5, a third exemplary system is shown to implement a second embodiment of a method of automated order picking according to this disclosure. The third exemplary system differs from the first exemplary system in that the third exemplary system may include only the second platform 8, the second 3D camera device 22, the second robotic arm 6 and the control device 1 (the fourth 3D camera device 24 can also be used in some embodiments in a manner as described in relation to the first embodiment). In the second embodiment, all order items of an order are placed on the second platform 8 in advance (i.e., the order items are the second-platform objects 20). It is noted that the order may include only one order item, but for the sake of clarity, the plural form is used hereinafter, and this disclosure is not limited in this respect. The control device 1 controls the second 3D camera device to capture a 3D image of the second-platform objects 20 that are included in the order, and to transmit the 3D image to the control device 1, so that the control device 1 can calculate a volume of each of the second-platform objects 20 based on the 3D image.

Then, the control device 1 selects a packing box of which a size fits the volumes of the order items that are placed on the second platform 8, and controls the second robotic arm 6 to pick up the order items from the second platform 8 and to place the order items into the packing box according to the optimal packing arrangement for the order items.

Details of selecting the packing box and bringing the order items from the second platform 8 to the packing box are the same as those described for the first embodiment, and thus are not repeated herein for the sake of brevity. In some embodiments, the third exemplary system may be provided with a track 200 that extends from the second platform area to the packing area 9, and the second robotic arm 6 is placed on the track 200, so that the second robotic arm 6 is movable between the second platform area and the packing area 9.

In summary, in the first embodiment of the method of automated order picking according to this disclosure, the control device 1 controls a robotic arm to pick up the first-platform objects 10 one by one from the first platform 7, to acquire the identification code and the volume of the picked one of the first-platform objects 10, and to put the picked one of the first-platform objects 10 on the second platform 8. Then, after determining that all the order items of an order have been placed on the second platform 8, the control device 1 selects a packing box that fits the order items in size, and controls the same robotic arm or a different robotic arm to pick up the order items and to put the order items into the packing box, thereby completing the packing operation. In the second embodiment of the method of automated order picking according to this disclosure, the order items have been placed on the second platform 8 in advance, and the control device 1 selects a packing box that fits the order items in size, and controls a robotic arm to pick up the order items and to put the order items into the packing box, thereby completing the packing operation. As a result, the embodiments can avoid human errors in determining a size of the packing box, which may result in waste of packing material due to use of an oversized box, or result in the need to repack due to use of an undersized box. In addition, using the robotic arm(s) in place of manual packing may save manpower and enhance the efficiency in packing and shipping.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of automated order picking, comprising:
A) by a first three-dimensional (3D) camera device, capturing a first 3D image of first-platform objects that are placed on a first platform, and transmitting the first 3D image to a control device;
B) by the control device, controlling a first robotic arm to pick up one of the first-platform objects that is placed on the first platform based on the first 3D image;
C) by a code reader unit, acquiring an identification code of the picked one of the first-platform objects, and transmitting the identification code to the control device;
D) by a second 3D camera device, capturing a second 3D image of the picked one of the first-platform objects, and transmitting the second 3D image to the control device;
E) by the control device, calculating a volume of the picked one of the first-platform objects based on the second 3D image;
F) by the control device, controlling the first robotic arm to place the picked one of the first-platform objects on an area of a second platform that is currently empty, the picked one of the first-platform objects that has been put on the second platform serving as a second-platform object;
G) repeating steps A)to F) to make the second platform have a plurality of the second-platform objects thereon; and
H) by the control device, upon determining that the second-platform objects include all order items of an order based on the identification codes that correspond to the second-platform objects, selecting a packing box of which a size fits the volumes of the order items, and controlling a second robotic arm to pick up the order items from the second platform and to place the order items into the packing box.

2. The method of claim 1, wherein step H) includes:
calculating an optimal packing order for the order items based on the volumes of the order items; and
controlling the second robotic arm to put the order items into the packing box according to the optimal packing order.

3. The method of claim 1, wherein the second platform includes a weighing scale for measuring a weight of the second-platform objects placed on the second platform, and step H) includes:
acquiring the weight of each of the second-platform objects based on the weight measured by the weighing scale; and
controlling, based on the weights of the second-platform objects, the second robotic arm to put the order items into the packing box in an order from heaviest to lightest.

4. The method of claim 1, wherein the code reader unit includes at least one barcode scanner that are disposed next to the first platform, and step C) includes
by the at least one barcode scanner, scanning a barcode disposed on the picked one of the first-platform objects to acquire the identification code; and
wherein the second 3D camera device is disposed next to the second platform, and step D) includes
capturing the second 3D image when the first robotic arm brings the picked one of the first-platform objects to the second platform.

5. The method of claim I, wherein the code reader unit includes a radio-frequency identification (RFID) tag reader that is disposed next to the first platform, and step C) includes
by the RFID tag reader, reading an RFID tag that is disposed on the picked one of the first-platform objects to acquire the identification code; and
wherein the second 3D camera device is disposed by the second platform, and step D) includes
capturing the second 3D image when the first robotic arm brings the picked one of the first-platform objects to the second platform.

6. The method of claim wherein the second platform has a plurality of placement areas that are arranged in an array, and the area in step F) is one of the placement areas.

7. The method of claim 6, further comprising:
by a third 3D camera device, capturing a third 3D image of the first robotic arm that is holding the picked one of the first-platform objects, and transmitting the third 3D image to the control device;
by the control device, analyzing the third 3D image to obtain a distance between a central point of the picked one of the first-platform objects and a contact point at which the first robotic arm contacts the picked one of the first-platform objects; and
by the control device, controlling the first robotic arm to place the picked one of the first-platform objects on the area of the second platform based on the distance between the contact point and the central point of the picked one of the first-platform objects, so that the picked one of the first-platform objects is entirely disposed within the area.

8. The method of claim 1, wherein the second 3D camera device is disposed next to the second platform, and step D) includes: capturing the second 3D image when the first robotic arm brings the picked one of the first-platform objects to the second platform, the second 3D image containing a top surface of the second platform;
wherein step F) includes
finding an area of the second platform that is currently empty based on the volume of the picked one of the first-platform objects and the top surface of the second platform as shown in the second 3D image to serve as the area for placement of the picked one of the first-platform objects,
controlling the first robotic arm to place the picked one of the first-platform objects on the area of the second platform thus determined, and
recording correspondence among coordinates of the area that is now occupied by the picked one of the first-platform objects, the volume of the picked one of the first-platform objects and the identification code that corresponds to the picked one of the first-platform objects; and
wherein step H) includes
by the control device, controlling the second robotic arm to pick up each of the order items from the second platform based on the coordinates that correspond to the identification code of the order item, and to put the order item into the packing box.

9. The method of claim 1, wherein the packing box selected by the control device is placed in a packing area, said method further comprising:
by a packing-area 3D camera device, capturing a 3D box image that shows an inner space of the packing box, and transmitting the 3D box image to the control device; and
wherein step H) includes
calculating an optimal packing arrangement for the order items with respect to the packing box based on the inner space of the packing box as shown in the 3D box image, and
controlling the second robotic arm to place each of the order items into a respective place in the packing box based on the optimal packing arrangement thus calculated. 25

10. The method of claim 1, further comprising:
by the control device, calculating a first moving trajectory for the first robotic arm and a second moving trajectory for the second robotic arm in terms of time and path, so as to avoid collision between the first robotic arm and the second robotic arm when the first robotic arm moves along the first moving trajectory and the second robotic arm moves along the second moving trajectory.

11. The method of claim 1, wherein the first robotic arm and the second robotic arm are the same robotic arm, the packing box selected by the control device is placed in a packing area, and the first robotic arm is disposed on a track that extends from a first platform area where the first platform is placed to the packing area through a second platform area where the second platform is placed, so that the first robotic arm is movable between the first platform area and the second platform area, and between the second platform area and the packing area.

12. A system of automated order picking, comprising:
a control device;
a first three-dimensional (3D) camera device that is electrically connected to and controlled by said control device;
a first robotic arm that is electrically connected to and controlled by said control device;
a code reader unit that is electrically connected to and controlled by said control device;
a second 3D camera device that is electrically connected to and controlled by said control device; and
a second robotic arm that is electrically connected to and controlled by said control device;
wherein said control device, said first 3D camera device, said first robotic arm, said code reader unit, said second 3D camera device and said second robotic arm cooperatively perform the method of claim 1.

13. A method of automated order picking, comprising:
A) by a three-dimensional (3D) camera device, capturing a 3D image of at least one object that is included in an order and that is placed on a platform, and transmitting the 3D image to a control device;
B) by the control device, calculating a volume of the at least one object based on the 3D image; and
C) by the control device, selecting a packing box of which a size fits the volume of the at least one object, and controlling a robotic arm to pick up the at least one object from the platform and to place the at least one object into the packing box.

14. The method of claim 13, wherein the at least one object includes a plurality of objects, and the 3D image captured in step A) contains the objects that are placed on the platform;
wherein step B) includes: calculating the volume of each of the objects based on the 3D image;
wherein the size of the packing box selected in step C) fits the volumes of the objects, and step C) further includes:
calculating an optimal packing order for the objects based on the volumes of the objects; and
controlling the robotic arm to put the objects into the packing box according to the optimal packing order.

15. The method of claim 14, wherein step C) includes:
controlling another 3D camera device to capture a 3D box image that shows an inner space of the packing box, and to transmit the 3D box image to the control device;
calculating an optimal packing arrangement for the objects with respect to the packing box based on the inner space of the packing box as shown in the 3D box image; and
placing each of the objects into a respective place in the packing box based on the optimal packing arrangement thus calculated.

16. The method of claim 13, wherein the packing box selected by the control device is placed in a packing area, and the robotic arm is disposed on a track that extends from a platform area where the platform is placed to the packing area, so that the robotic arm is movable between the platform area and the packing area.

17. A system of automated order picking, comprising:
a control device;
a three-dimensional (3D) camera device that is electrically connected to and controlled by said control device; and
a robotic arm that is electrically connected to and controlled by said control device;
wherein said control device, said 3D camera device and said robotic arm cooperatively perform the method of claim 13.
